(19) United States
(12) Patent Application Publication
(10) Pub. No.: US 2004/0109746 A1
(43) Pub. Date: Jun. 10, 2004

(54) Overhead travelling carriage system

(75) Inventor: Takashi Suzuki, Kagamigahara-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Murata Kikai Kabushiki Kaisha, Kyoto-shi (JP)

(21) Appl. No.: 10/721,995

(22) Filed: Nov. 26, 2003

(30) Foreign Application Priority Data
Dec. 9, 2002 (JP) 2002-356598

(51) Int. Cl. B65G 67/00

(52) U.S. Cl. 414/373

(57) ABSTRACT

It is an object of the present invention to provide an overhead travelling carriage system comprising overhead travelling carriages each conveying an article and a running path along which the overhead travelling carriages run, wherein buffers each temporarily storing articles are provided so that an article from the buffer can be delivered to the overhead travelling carriage in a short time, vice versa. Roller conveyors 8, 8 are mounted in an overhead travelling carriage 10 to load and unload an article (a cassette 9 or the like) in a direction orthogonal to a direction in which a carriage body advances. Buffers each comprising roller conveyors 46, 46 are arranged at a side of a running path 2 and at a height corresponding to the roller conveyors 8, 8 of the overhead travelling carriage 10.

### FIELD OF THE INVENTION

The present invention relates to the configuration of an overhead travelling carriage system comprising overhead travelling carriages each conveying an article and a running path along which the overhead travelling carriages run.

### BACKGROUND OF THE INVENTION

An overhead travelling carriage system is known which is installed in a clean room in a semiconductor plant or the like by laying a running path along processing devices and automatic warehouses and which conveys articles by allowing overhead travelling carriages to run automatically on the running path.

Stations of the processing devices and buffers that temporarily store articles to be supplied to the stations are arranged below the running path. A hoist with a chuck is mounted in each of the overhead travelling carriages so as to deliver and receive articles to and from the stations or buffers in a vertical direction.

Such an overhead travelling carriage system is disclosed in the Japanese Patent Publication No. 3067656. In this publication, storage rack members each having a rack on which articles can be placed are each mounted above the floor surface near the corresponding processing station and below the running path so as not to move with respect to the running path. Specifically, this system is configured as described below.

As shown in FIGS. 6 and 9 of this publication, two rack frames 16a, 16a are mounted on a rail 1 with a predetermined spacing between them in a longitudinal direction, the rail 1 being a running path for overhead travelling carriages V. Upper horizontal portions 16a′, 16a′ are attached to the top surface of the rail 1, and a rack 16c is placed on lower horizontal portions 16a″, 16a″ to constitute a storage rack member 16. An article 4 is unloaded from the overhead travelling carriage V onto the rack 16c via a hoist. There is a sufficient distance between the upper horizontal portion 16a′ and the lower horizontal portion 16a″ of each rack frame 16a so as to prevent the overhead travelling carriage V running along the rail 1 from colliding against the articles 4 placed on the rack 4.

The storage rack member 16 is arranged obliquely above a processing station P1 and below the rail 1. If the processing station P1 processes a plurality of articles 4, 4, . . . all together, the articles 4 conveyed on the respective overhead travelling carriage V are placed on the storage rack member 16. After a predetermined number of articles 4 have been placed on the storage rack member 16, the overhead travelling carriage V supplies the articles 4, 4, . . . to the processing station P1 all together.

Furthermore, although not described in the embodiments of the publication, when the maximum number of articles 4, 4, . . . that can be loaded into the processing station P1 have already been loaded, if a different overhead travelling carriage V conveying a new article 4 reaches the processing station P1, then the new article 4 can be placed on the storage rack member 16. Thus, the storage rack member 16 acts as a buffer that temporarily stores the articles 4, 4, . . .

A description will be given of the delivery of the article 4 from the overhead travelling carriage V to the storage rack member 16 and vice versa. The overhead travelling carriage V runs while using a chuck on the hoist to convey an article 4. During running, a fall preventing mechanism supports the opposite ends (the front and rear ends with respect to the direction in which the overhead travelling carriage V runs) of the bottom surface of each article 4 (alternatively, a gap is created between the fall preventing mechanism and each end of the bottom surface of the article 4 so that even if the article 4 falls, the fall preventing mechanism can receive it). When the overhead travelling carriage V is stopped above the storage rack member 16, the fall preventing mechanism is first activated to release the bottom of the article 4.

A plurality of winding drums are attached to the main body of the hoist. A wire is wound around each of the winding drums. The hoist is provided with an elevating and lowering portion that can be elevated and lowered via the wire. A chuck provided at the bottom of the elevating and lowering portion holds the article 4. The wires are fed from the respective winding drums to lower the elevating and lowering portion holding the article 4, from the hoist main body.

Then, the article 4 is placed on the rack 16c of the storage rack member 16. The chuck holding the article 4 is then opened. Then, the winding drums are operated to wind the wires to elevate and place the elevating and lowering portion in the overhead travelling carriage V.

As described above, in the above publication, the hoist is used to deliver the article 4 from the overhead travelling carriage V to the storage rack member 16 and vice versa. It takes long time to use the hoist to transfer the article 4, so that there has been a demand for improvements in this system. It is thus an object of the present invention to provide an overhead travelling carriage system that enables an article from an overhead travelling carriage to be delivered promptly to a buffer temporarily storing articles, while enabling an article from the buffer to be delivered promptly to the overhead travelling carriage.

### SUMMARY OF THE INVENTION

A description has been given of the problems to be solved by the present invention, and a description will be given of the means for solving these problems.

The present invention provides an overhead travelling carriage system comprising overhead travelling carriages each conveying an article and a running path along which the overhead travelling carriages run, wherein conveying means is mounted in each of the overhead travelling carriages to load and unload an article in a direction orthogonal to a direction in which a carriage body advances, and buffers are arranged at a side of the running path at a height corresponding to the conveying means of each overhead travelling carriage, the buffers each comprising loading and unloading means for delivering and receiving an article to and from the conveying means of the overhead travelling carriage.

### BRIEF DESCRIPTION OF THE DRAWINGS

FIG. 1 is a plan view schematically showing the configuration of an overhead travelling carriage system.

FIG. 2 is a plan view of a processing device and an automatic warehouse.

FIG. 3 is a front view of the processing device.

FIG. 4 is a front view of the processing device.

FIG. 5 is a front sectional view of the automatic warehouse.

FIG. 6 is a perspective view of an overhead travelling carriage.

FIG. 7 is a side view of the overhead travelling carriage showing that a cassette is placed on roller conveyors.

FIG. 8 is a side view of the overhead travelling carriage, in which FIG. 8A shows that moving mechanisms are placed at a transfer position and FIG. 8B shows that the moving mechanisms are placed at a retreat position.

FIG. 9 is a block diagram showing a control arrangement for the overhead travelling carriage.

### DETAILED DESCRIPTION OF THE PREFERRED EMBODIMENTS

An embodiment of the present invention will be described below with reference to the drawings.

The fore-and-aft and lateral positions of constituent members will be described below by defining the direction in which an overhead travelling carriage 10 advances as a forward direction, unless otherwise specified.

Furthermore, in the description below, a cassette 9 in which a large number of semiconductor wafers are housed is specifically referred to as an article conveyed on the overhead travelling carriage 10. However, the article is not limited to the cassette 9. The cassette 9 is provided with a large number of shelves arranged in a vertical direction. Wafers are housed on each shelf in a horizontal direction.

Furthermore, in the description below, roller conveyors 8, 8 are referred to as conveying means of the overhead travelling carriage 10 which loads and unloads an article in a direction orthogonal to the direction in which the carriage body advances as set forth in the claims. Roller conveyors 54, 54 are referred to as input and output means provided in an upper station. Roller conveyors 46 are referred to as loading and unloading means provided in a buffer. However, the present invention is not limited to these arrangements.

First, the configuration of the overhead travelling carriage system 1 will be described in brief.

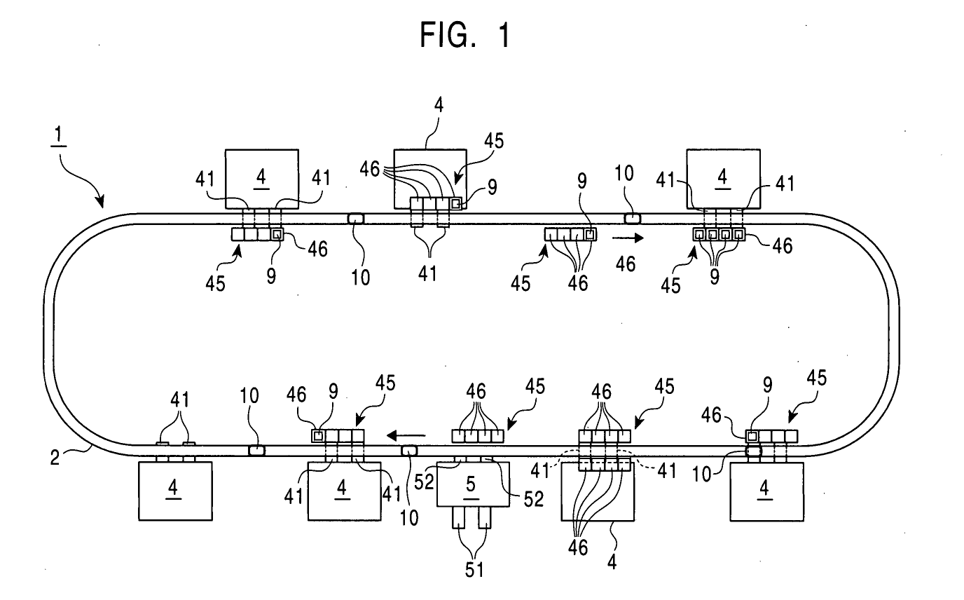

As shown in FIG. 1, a running path 2 along which the overhead travelling carriages 10, 10, . . . move is laid like a loop in a clean room in a semiconductor plant or the like. One automatic warehouse 5 and a plurality of processing devices 4, 4, . . . are arranged along the running path 2 outside the loop to constitute the overhead travelling carriage system 1.

The automatic warehouse 5 is a small storage in which cassettes 9, 9, . . . are temporarily stored. Using the automatic warehouse 5 as a starting point, the processing devices 4, 4, . . . are arranged in the order of process steps in the direction shown by a thick arrow in the figure. A system separate from the overhead travelling carriage system 1 inputs cassettes 9 to the automatic warehouse 5, in which the cassettes 9 are temporarily stored. When the overhead travelling carriage 10 arrives at the automatic warehouse 5, the cassette 9 is outputted and transferred to the overhead travelling carriage 10. The cassette 9 is sequentially conveyed to the processing devices 4, 4, . . . in accordance with the order of the process steps. Once the processing in the processing devices 4, 4, . . . has been completed, the cassette 9 is inputted to the automatic warehouse 5 again and the outputted to the system separate from the overhead travelling carriage system 1.

Now, the processing device 4 will be described.

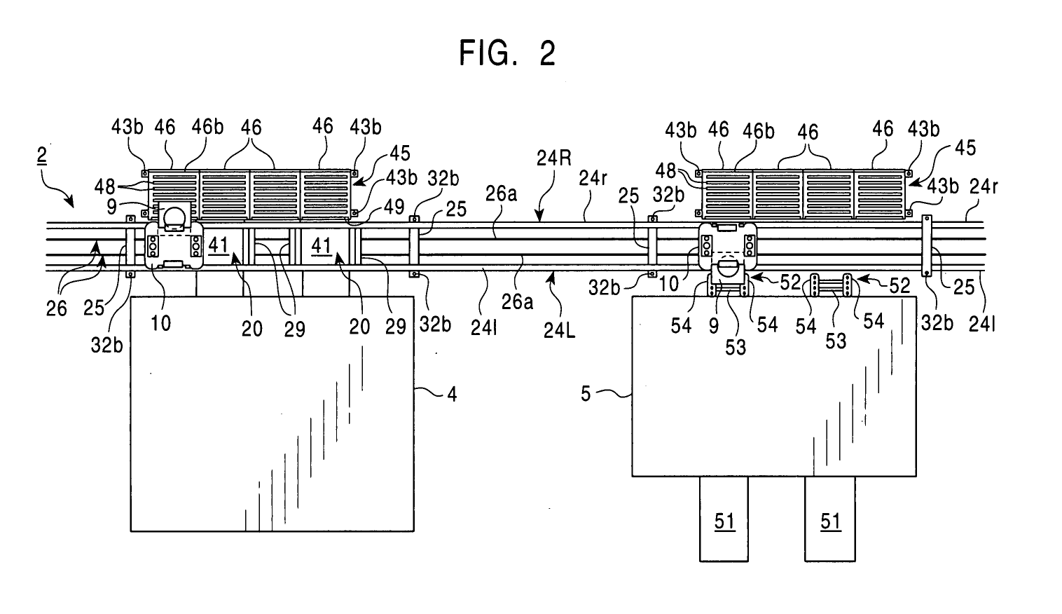

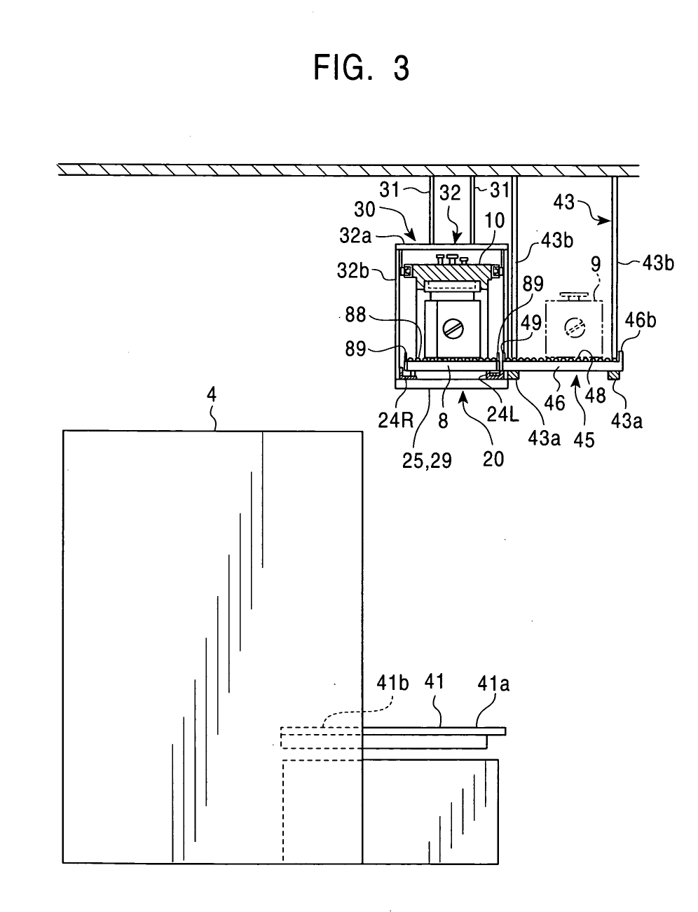

As shown in FIGS. 2 and 3, an input port and an output port are formed in the lower part of a side of the processing device 4 which is opposite to the running path 2. The input port and the output port are each provided with a ground station 41. The ground stations 41, 41 project from the interior to exterior of the processing device 4 and each have an end (closer to the running path) 41a located immediately below the running path.

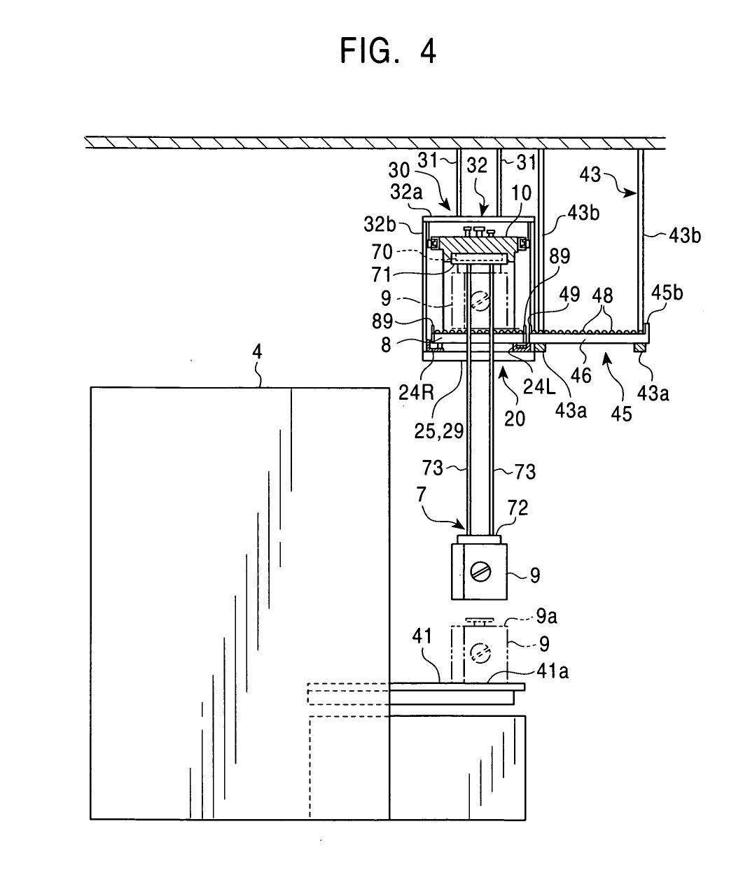

Furthermore, passage ports 20, 20 are formed in the running path above the corresponding ground stations 41, 41 so that the cassette 9 can pass through each passage port 20 in the vertical direction. As shown in FIG. 4, the cassette 9 is passed through the passage port 20 in the vertical direction so as to be transferred between the outer end 41a of each station 41 and the overhead travelling carriage 10 on the running path 2.

The ground station 41 is provided with conveying means such as roller conveyors to convey the cassette 9 between the outer end 41a and an inner end 41b (opposite to the running path 2) of the ground station 41.

A transfer device comprising a horizontal articulated transfer hand is provided in the processing device 4. The transfer device transfers the cassette 9 between the inner end 41b of the station 41 and a housing shelf in the processing device 4. Then, a plurality of cassettes 9 are stored on the housing shelf in the processing device 4. Wafers are taken out of the cassettes 9, 9, . . . and then subjected to processing such as cleaning all together. Thus, the processing device 4 processes wafers from the plurality of cassettes 9, 9, . . . at a time.

As shown in FIGS. 2 and 3, a buffer 45 is arranged obliquely above the ground stations 41, 41 of the processing device 4 at the laterally inner side (the inner side of the loop-like running path) of the running path to store the cassettes 9 temporarily. The buffer 45 is suspended from the ceiling surface of the clean room via suspending members 43, 43 and is arranged in proximity to and parallel with the running path 2.

Each suspending member 43 is composed of a lower frame 43a and supporting rods 43b, 43b extending perpendicularly to a front end and rear end (with respect to the running direction of the running path 2), respectively, of the lower frame 43a. The supporting rods 43b, 43b are suspended from the ceiling surface of the clean room. The two suspending members 43, 43 are arranged parallel with the running path 2. The buffer 45 is fixed to the lower frames 43a, 43a of the suspending members 43, 43 so that its placement surface extends in the horizontal direction.

The arrangement supporting the buffer 45 is not limited to the suspending members 43, 43 but may be fixed to supporting members provided on the floor surface of the clean room so as to extend in the vertical direction. That is, this arrangement is not particularly limited.

The buffer 45 comprises a plurality of roller conveyors 46, 46, . . . as means for loading and unloading the cassette 9. The roller conveyors 46, 46, . . . are provided along the running path 2. One cassette 9 is temporarily stored on one roller conveyor 46.

Each roller conveyor 46 comprises a plurality of rollers 48, 48, . . . and driving means (not shown in the drawings) for the rollers 48, 48, . . . , the rollers 48, 48, . . . and the driving means all being provided within a frame that appears square in a plan view. Each of the rollers 48, 48, . . . is formed to be slightly longer than the width of the bottom surface of the cassette 9 and partly projects from the top surface of the frame. The driving means is constructed by attaching a driving pulley to a motor shaft of a driving motor and winding a belt around the driving pulley and follower pulleys attached to corresponding rotating shafts of the rollers 48, 48, . . .

Thus, each of the roller conveyors 46, 36, . . . is provided with the driving means and can thus driven independently. The cassette 9 on the roller conveyor 46 is fed by the rollers 48, 48, . . . and conveyed in a lateral direction with respect to the running direction of the running path 2.

In the above configuration, each of the roller conveyors 46, 46, . . . of the buffer 45 is provided with the driving means. However, the roller conveyors 46, 46, . . . may be operated in unison with the roller conveyors 8, 8 of the overhead travelling carriage 10. For example, instead of providing the roller conveyors 46, 46, . . . of each buffer 45 with the driving means, each of the roller conveyors 8, 8 of the overhead travelling carriage 10 may be provided with a transmitting roller that can move forward and backward. In this case, the transmitting rollers are abutted against the roller conveyor 46 to transmit a driving force to it. Consequently, the roller conveyors 46, 46, . . . of the buffer 45 can be moved.

Conversely, the roller conveyors 46, 46, . . . of each buffer 45 may each be provided with a transmitting roller that can move forward and backward. In this case, the transmitting roller is abutted against the roller conveyors 8, 8 of the overhead travelling carriage 10 to transmit a driving force from the corresponding one of the roller conveyors 46, 46, . . . of the buffer 45 to the roller conveyors 8. Consequently, the roller conveyors 8, 8 of the overhead travelling carriage 10 can be moved.

The means for loading and unloading the cassettes 9, 9, . . . onto and from the buffer 45 is not limited to the roller conveyors 46, 46, . . . Other arrangements may be used.

The buffer 45 is arranged so that conveying surfaces of the roller conveyors 46, 46, . . . are at the same height as conveying surfaces of the roller conveyors 8, 8 of the overhead travelling carriage 10, running on the running path 2.

Furthermore, a stopper 49 is provided at an end of each roller conveyor 46 which is closer to the running path 2. The stopper 49 is configured to move freely in the vertical direction so as to elevate or lower from the conveying surface of the roller conveyor 46. The stopper 49 is elevated from the conveying surface to prevent the cassette 9 on the roller conveyor 46 from falling. On the other hand, the stopper 49 is lowered from the conveying surface to allow the cassette 9 to be delivered to the overhead travelling carriage 10.

Moreover, a projecting portion 46b is projected from an end of each roller conveyor 46 which is opposite to the running path 2. The projecting portion 46b acts as a stopper to prevent the cassette 9 on the roller conveyor 46 from falling from a side of the roller conveyor 46 which is opposite to the running path 2. The means for preventing the cassette 9 on the roller conveyor 46 from falling is not limited to the arrangement composed of the stopper 49 and the projecting portion 46b. Other arrangements may be used.

In the above arrangement, the buffer 45 is arranged obliquely above the processing device 4 at the laterally inner side (the inner side of the loop-like running path) of the running path 2.

However, as shown in FIG. 1, if the processing device 4 is lower than the running path 2, the buffer 45 may be arranged above the processing device 4 at the laterally outer side (the outer side of the loop-like running path) of the running path 2.

If the buffers 45, 45 are arranged above the processing device 4 at the respective sides of the running path 2, the overhead travelling carriages 10 sequentially transfer the respective cassettes 9 only to the buffers 45 arranged at the right or left of the running path 2, first. After all the roller conveyors 46, 46, . . . of the buffers 45 arranged at either side have been loaded with cassettes 9, 9, . . . , other cassettes 9 are transferred to the roller conveyors 46a, 46a, . . . of the buffers 45 arranged on the opposite side.

Alternatively, the overhead travelling carriages 10 may start transferring the respective cassettes 9 from the upstream or downstream side of the running path 2 and alternate between the buffer 45 arranged at one side of the running path 2 and that arranged at the other side. The order of transfer of the cassettes 9, 9, . . . to the buffers 45, 45 is not particularly limited.

Moreover, each buffer 45 may be arranged along the running path 2 and between the processing devices 4, 4.

If the buffer 45 is arranged along the running path 2 and between the processing devices 4, 4, the overhead travelling carriages 10 first transfer cassettes 9 to the buffer 45 located above the processing device 4 arranged upstream or downstream of the buffer 45 located between the processing devices 4. After all the roller conveyors 46, 46, . . . of the buffer 45 located above the processing device 4 have been loaded with cassettes 9, 9, . . . , other cassettes 9 are transferred to the respective roller conveyors 46a, 46a, . . . of the buffer 45 located between the processing device 4.

The positions of the buffers 45, 45, . . . are not particularly limited provided that they are arranged at the side of the running path 2. Thus, other arrangements may be used.

Now, the automatic warehouse 5 will be described.

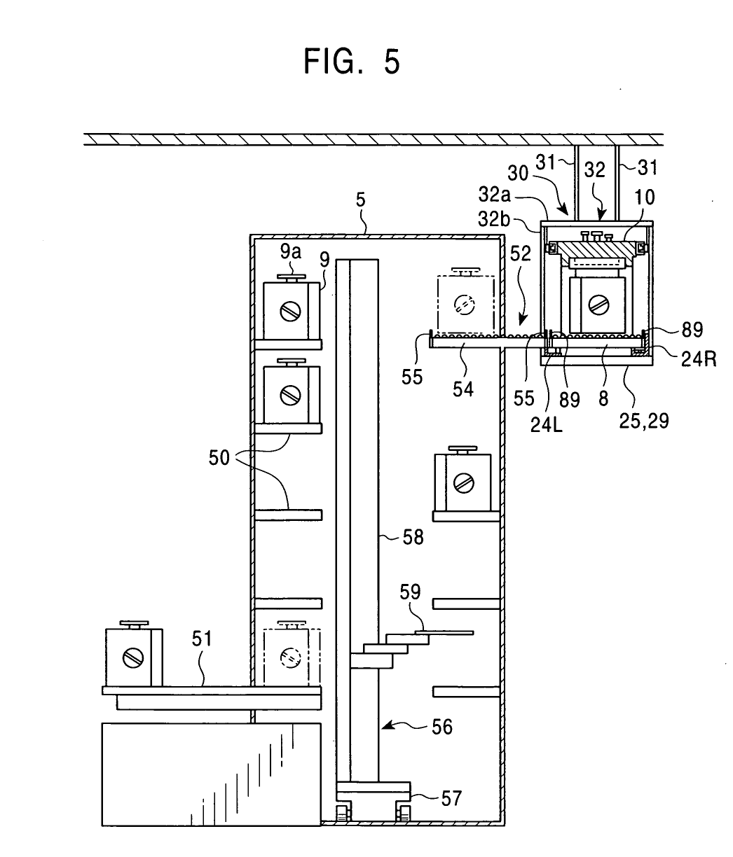

As shown in FIGS. 2 and 5, an input port and an output port are formed in the upper part of a side of the automatic warehouse 5 which is opposite to the running path 2. The input port and the output port are each provided with upper stations 52, 52 to which the cassettes 9 are transferred. The upper stations 52, 52 project from the interior to exterior of the automatic warehouse 5. The outer ends (closer to the running path 2) of the upper stations 52, 52 are arranged at the side of the running path 2 (outside and close to the loop-like running path).

Each upper station 52 comprises a pair of roller conveyors 54, 54 as input and output means. The pair of roller conveyors 54, 54 is provided in a fore-and-aft direction with respect to the running direction of the running path 2. The roller conveyors 54, 54 are located at the same height as that of the roller conveyors 8, 8 of the overhead travelling carriage 10 on the running path 2. The roller conveyors 54, 54 are connected together via connection members 53, 53, . . . so as to maintain a fixed spacing between the roller conveyors 54, 54.

The pair of roller conveyors 54, 54 supports the opposite ends (the front and rear ends with respect to the running direction of the running path 2) of the bottom surface of the cassette 9 to convey it in the lateral direction with respect to the running direction of the running path 2. Stoppers 55, 55 are provided at the outer end (closer to the running path 2) and inner end (closer to the automatic warehouse 5), respectively, of each roller conveyor 54. The stoppers 55, 55 are configured to move freely in the vertical direction so as to elevate or lower from a conveying surface of the roller conveyor 54.

The stoppers 55, 55 are elevated from the conveying surface to prevent the cassette 9 placed on the roller conveyors 54, 54 from falling. On the other hand, the stoppers 55, 55 is lowered from the conveying surface to allow the cassette 9 to be delivered to and received from the overhead travelling carriage 10 or a stacker crane 56 in the automatic warehouse 5.

Furthermore, the buffer 45 is arranged opposite the upper stations 52, 52 of the automatic warehouse 5 across the running path 2. The buffer 45 is arranged at the laterally inner side (the inner side of the loop-like running path) of the running path 2. The cassette 9 from each of the upper stations 52, 52 of the automatic warehouse 5 is transferred to the buffer 45 via the overhead travelling carriage 10.

Furthermore, an input port and an output port are formed in the lower part of a side of the automatic warehouse 5 which is opposite to the running path 2. The input port and the output port are each provided with lower station 51, 51.

The lower stations 51, 51 project from the interior to exterior of the automatic warehouse 5 and are provided with conveying means such as roller conveyors. The conveying means inputs and outputs the cassette 9 to and from the automatic warehouse 5. The lower stations 51, 51 are used, for example, to allow an operator to input and output urgent articles.

The automatic warehouse 5 contains housing portions formed in a side part closer to the running path 2 and in a side part opposite to the running path 2, respectively. The stacker crane 56 is arranged in the central space between the housing portions. A large number of shelves 50, 50, . . . are provided in the housing portions to house the cassettes 9. A rail (not shown in the drawings) is laid on the floor surface in the central space between the housing portions so as to extend in the running direction of the running path 2. The stacker crane 56 comprises a running carriage 57 that runs on the rail, a mast 58 provided on the running carriage 57 so as to extend in the vertical direction, and a horizontal articulated transfer device 59 that elevates and lowers along the mast 58. The stacker crane 56 is adapted to move along the rail in the horizontal direction. The tip portion of the transfer device 59 is shaped like a fork and is used to scoop up the bottom surface of the cassette 9. Using a combination of the horizontal movement of the running carriage 57 and the vertical movement of the transfer device 59, the cassette 9 can be transferred to the lower station 51, the upper station 52, and the shelves 56, 56, . . .

With the above arrangement, cassettes 9, 9, . . . from a system outside the overhead travelling carriage system 1 are delivered to the lower stations 51, 51 of the automatic warehouse 5. The upper stations 52, 52 of the automatic warehouse 5 deliver the cassettes 9, 9, . . . to the respective overhead travelling carriages 10 on the running path 2. The stacker crane 56 transfers the cassette 9 between the lower station 51 and the shelf 50, between the upper station 52 and the shelf 50, or between the lower station 51 and the upper station 52.

Now, the configuration of the running path 2 will be described.

As shown in FIG. 2, the running path comprises a pair of rails 24L and 24R, joining members 25, 25, . . . that connect the bottom surfaces of the rails 24L and 24R together, and fall preventing members 26, 26 installed between the rails 24L and 24R in the running direction of the running path 2. The running path 2 is suspended from the ceiling of the clean room by the suspending members 30, 30, . . .

As shown in FIG. 3, the suspending member 30 comprises a pair of suspending rods 31, 31 and a suspending frame 32. The suspending frame 32 is composed of a top frame 32a and side rods 32a, 32b. The laterally opposite ends of the top frame 32a are fixed to the corresponding lower ends of the suspending rods 31, 31. The upper ends of the side rods 32b, 32b are fixed to the corresponding laterally opposite ends of the top frame. The laterally opposite ends of the joining members 25 are fixed to the corresponding lower ends of the side rods 32b, 32b.

Thus, the joining members 25, 25, . . . are suspended by the suspending members 30, 30, . . . The bottom surfaces of the rails 24L, 24R are fixed to the respective lateral ends of the top surfaces of the joining members 25, 25, . . .

As shown in FIG. 2, the large number of joining members 25, 25, . . . are arranged at intervals in the running direction of the running path 2. The joining members 25, 25, . . . serve to maintain a fixed distance between the two rails 24L, 24R.

The joining members 25, 25, . . . may simply connect the rails 24L and 24R together at their bottom surfaces without being suspended by the suspending members 30, 30, . . . , as required.

However, the joining members 25, 25, . . . are not arranged above the stations 41, 41 of the processing device 4. Joining members 29, 29 are provided above the stations 41, 41 and between the bottom surfaces of the rails 24L, 24R. A passage port 20 is formed so as to be surrounded by the joining members 29, 29 and the rails 24L, 24R.

The rail 24L (24R) is composed of a plurality of rail members 24l, 24l, . . . (24r, 24r, . . . ) having an appropriate length and fixedly supported on the joining members 25, 25 at least at its longitudinally opposite ends. The rail members 24l, 24l, . . . (24r, 24r, . . . ) are connected together in the running direction of the running path 2 to constitute the rail 24L (24R).

Each of the rail members 24l, 24r comprises a horizontal running portion and guide portions provided at the laterally outer sides of the running portion so as to extend in the vertical direction, and has a L-shaped cross section. Moreover, the rail member 24l also has guide portions provided at the laterally inner sides of the running portion so as to extend in the vertical direction. Projecting portions are formed at the corresponding upper ends of the guide portions provided at the respective lateral sides of the rail member 24l, and stand opposite each other. A guide groove is formed so as to be surrounded by the running portion, guide portions, and projecting portions of the rail member 24l. Guide rollers 12, 12, described later, of the overhead travelling carriage 10 are guided along the guide groove. Then, the projecting portions prevent the guide rollers 12, 12 from slipping out of the guide groove.

Each fall preventing member 26 is composed of a plurality of fall preventing bars 26a, 26a, . . . having an appropriate length and connected together in the longitudinal direction. Two brackets are provided on the top surface of each joining member 25 (29) with a fixed lateral distance between them. Fall preventing bars 26a are removably attached to the brackets.

With the above arrangement, the fall preventing bars 26a, 26a, . . . are installed between the joining members 25, 25, . . . , 29, 29, . . . However, the fall preventing bars 26a, 26a, . . . are not arranged in the passage port 20.

Thus, according to the present embodiment, for safety, the two fall preventing members 26, 26 are installed between the rails 24L, 24R. Even if the cassette 9 falls from the overhead travelling carriage 10 or another member between the rails 24L, 24R, it is caught on the fall preventing members 26, 26 before colliding against the floor surface. The number, arrangement, and the like of fall preventing members 26, 26 are not particularly limited.

Now, the configuration of the overhead travelling carriage 10 will be described.

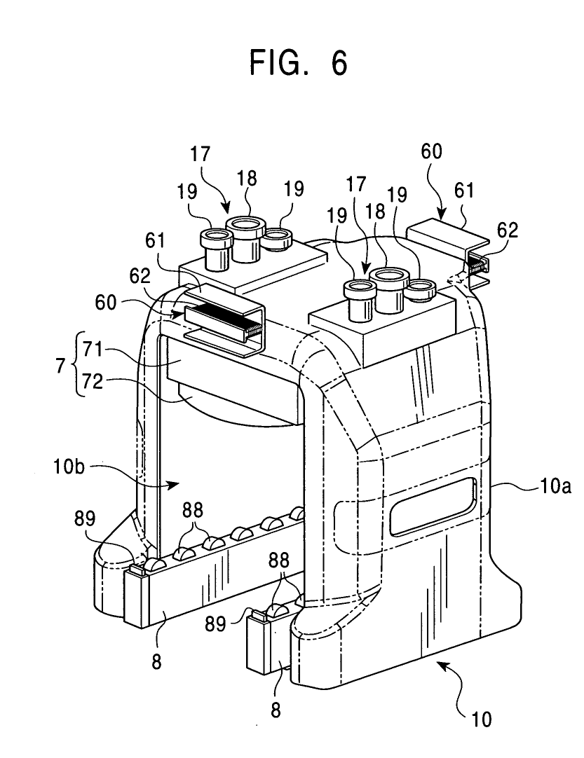

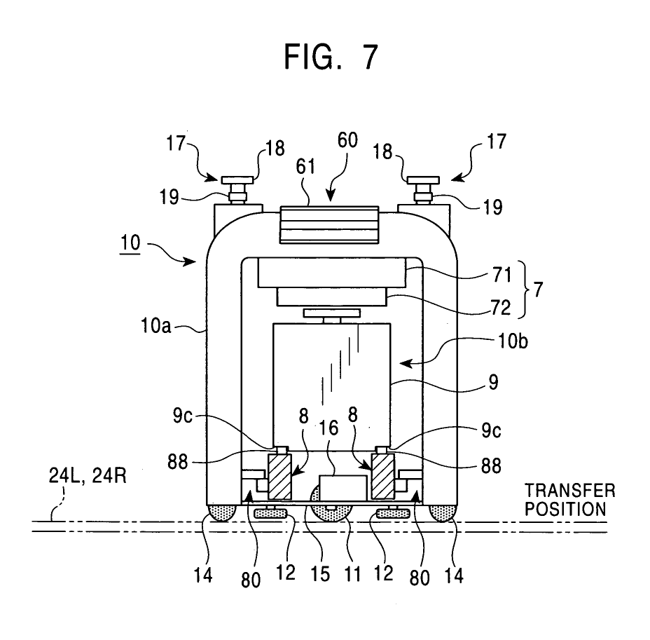

As shown in FIG. 6, the overhead travelling carriage 10 is provided with an article housing space 10b in the middle of the carriage main body 10a. The bottom and laterally opposite sides of the article housing space 10b are open so that the cassettes 9 can be passed through these areas (see FIG. 7). That is, the overhead travelling carriage 10 has transfer ports for the cassettes 9 in the right and left and at the bottom of the carriage main body 10a.

As shown in FIG. 7, the front and rear lower ends of the carriage main body 10a are connected together via a supporting member 15. A driving motor 16 is fixed to the supporting member 15 so that its longitudinal direction corresponds to the fore-and-aft direction of the carriage main body 10a. The driving motor 16 and its supporting member 15 are arranged at one of the laterally opposite ends of the carriage main body 10a so as not to interfere with the cassette 9 elevated and lowered from the article housing space 10b via a hoist 7. The top surface of the driving motor 16 is arranged below the conveying surfaces of the roller conveyors 8, 8 of the overhead travelling carriage 10 so as not to interfere with the conveyed cassette 9.

Driving wheels 11 are attached to the corresponding laterally outer sides of the driving motor 16 so that their axles extend in a laterally horizontal direction. The driving motor transmits power via a power transmission mechanism (not shown in the drawings) such as a bevel gear. The driving wheels 11 are arranged in the fore-and-aft central portion of the carriage main body 10a. In front of and behind each driving wheel, corresponding guide rollers 12, 12 are attached to the supporting member 15 so that their axles extend in the vertical direction. In a side view, the guide rollers 12, 12 appear to be arranged at fore-and-aft symmetrical positions with respect to the axle of the driving wheel.

Each driving wheel 11 projects downward from the bottom surface of the carriage main body 10a and abuts against the running portion of the rail member 24l. The guide rollers 12, 12 are guided along the guide groove in the rail member 24l.

A pair of follower wheels 14, 14 is provided at the lower end of the carriage main body 10a at its side end (rail 24R-side end) opposite to the driving wheel 14. The follower wheels 14, 14 are composed of caster wheels that can freely change their own directions. The follower wheels 14, 14 are arranged at the front and rear ends, respectively, of the bottom surface of the carriage main body 10a so that their axles extend in the horizontal direction.

Furthermore, as shown in FIG. 6, a pair of branching devices 17, 17 are provided in a front and rear portions, respectively, of the top surface of the carriage main body 10a. The branching devices 17, 17 are used if the running path 2 branches or in other cases. Each branching device 17 comprises a guide roller 18 arranged in a laterally central portion of the top surface of the carriage main body la and branching rollers 19, 19 arranged at the respective lateral sides of the guide roller 18. The rollers 18, 19, 19 are arranged so that their axles extend in the vertical direction. The branching rollers 19, 19 are configured to move freely in the vertical direction.

Moreover, pickup units 60, 60 are provided at the top of the carriage main body 10a at the respective lateral ends of the carriage main body 10a to obtain power from a feeder line installed above the running path 2. The weight of the pickup units 60, 60 takes up a large percentage of the total weight of the carriage main body 10a. Accordingly, the pickup units 60, 60 are arranged at the respective lateral sides of the carriage main body 10a to maintain the balance of the weight of the whole carriage main body. This enables the carriage body to run smoothly along, for example, a curved portion. Furthermore, since the running path 2 has a branched part, a feeder line laid at one side of the running path 2 may have to be installed at the opposite side of the running path 2 in some areas. Thus, by arranging the pickup units 60, 60 at the respective lateral sides of the carriage main body 10a, the overhead travelling carriage 10 can be supplied with power even on such a branched part or the like.

Each pickup unit 60 comprises an E-shaped ferrite core 61 and a pickup coil 62. The core 61 has projecting portions arranged at three positions, i.e. at its top, center, and bottom so as to extend in a laterally outer direction. The pickup coil 62 is wound around the central projecting portion. The core 61 is arranged so that feeder lines are located in an upper and lower concaves, respectively, formed between the central projecting portion and each of the top and bottom projecting portions.

The pickup coil 62 receives magnetic fields generated by conducting a high frequency current through the feeder lines. Then, an electromagnetic induction phenomenon is utilized to obtain power from a dielectric current generated in the pickup coil 62. In this manner, the pickup units 60 are supplied with power through the feeder lines in a non-contact manner to drive the driving motor 16 for the driving wheels 11 and to supply power to control equipment.

Furthermore, the overhead travelling carriage 10 comprises, within the article housing space 10b, the hoist 7 that delivers and receives the cassette 9 to and from the ground station 41 of the processing device 4 in the vertical direction and the pair of roller conveyors 8, 8 that deliver and receive the cassette 9 to and from the upper station 52 of the automatic warehouse 5 in a direction orthogonal to the direction in which the carriage body advances.

As shown in FIG. 4, a slide device 70 is provided on the top surface of the overhead travelling carriage 10 above the article housing space 10b. The main body 71 of the hoist 7 is attached to the slide device 70. The hoist main body 71 is provided with elevating and lowering means for elevating and lowering an elevating and lowering portion 72 with a chuck. The slide device 70 is adapted to move the hoist main body 71 in the direction orthogonal to the carriage body advancing direction. Accordingly, even if the ground station 41 is slightly offset from a position immediately below the hoist in the direction orthogonal to the advancing direction owing to an installation error or the like, the cassette 9 can be accurately transferred by moving the hoist main body 71 so that it is placed immediately above the placement portion of the outer end 41a of the ground station 41a.

If the rail 24R is located immediately above the placement portion of the outer end 41a of the ground station 41, a notch must be formed in the rail 24R.

In this connection, all the ground stations 41, 41, . . . may be located immediately below the overhead travelling carriage 10 sitting on the running path 2, while omitting the slide device 70 from the overhead travelling carriage 10. In this case, the hoist main body 71 is attached to the top surface of the carriage main body 10a, located above the article housing space 10b. The slide device 70 may be provided to adjust finely the outer end 41a of the ground station 41 to the placement portion.

Four winding drums are attached to the main body of the hoist 7. Belts 73, 73, . . . are wound around the respective winding drums, and the electing and lowering portion 72 is suspended via the belts 73, 73, . . . so as to elevate and lower freely. The elevating and lowering portion 72 is thus configured to elevate and lower freely, and is provided with a chuck at its bottom to hold the cassette 9. The chuck grips an upper flange 9a formed at the top of the cassette 9.

Furthermore, as shown in FIG. 6, the pair of roller conveyors 8, 8 are provided in front of and behind the article housing space 10, respectively, in the lower parts of the corresponding inner sides of the carriage main body 10a.

The roller conveyors 8, 8 are means for conveying the cassette 9 in the direction orthogonal to the carriage body advancing direction. Each roller conveyor 8 has a large number of rollers 88, 88, . . . arranged in the longitudinal direction (in the right and left of the carriage main body). The rollers 88, 88, . . . project partly from the top surface of the main body of the roller conveyor 8 to support the corresponding one of the opposite ends (the front and rear ends with respect to the advancing direction of the overhead travelling carriage 10) of the bottom surface of the cassette 9.

A driving motor is attached to one of the roller conveyors 8, and a driving pulley is attached to a driving shaft of the driving motor. Follower pulleys are attached to corresponding rotating shafts of the rollers 88, 88, . . . , and one belt is wound around the driving pulley and all the follower pulleys. Thus, all the rollers 88, 88, . . . are rotated synchronously.

No driving motors are provided for the other roller conveyor 8. The rollers 88, 88, . . . are thus configured to rotate freely. This provides conveying means using one of the conveyors 8 as a driving conveyor and the other conveyor 8 as a follower conveyor.

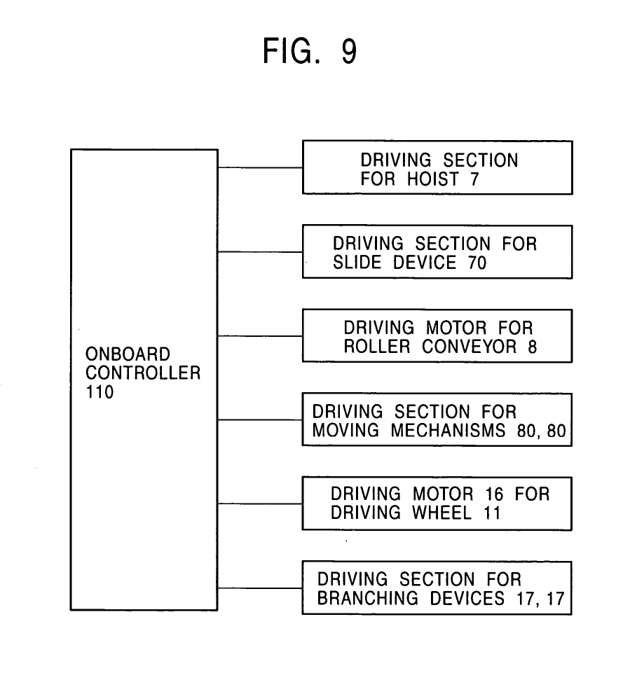

The opposite ends (the front and rear ends with respect to the advancing direction of the overhead travelling carriage 10) of the bottom surface of the cassette 9 are placed on the pair of roller conveyors 8, 8. More specifically, step portions 9c, 9c (see FIG. 9c) are formed at the respective ends of the bottom surface of the cassette 9. The step portions 9c, 9c are located on the rollers 88, 88, . . . of the pair of roller conveyors 8, 8 (see FIG. 7) to prevent the cassette 9 from shifting in the lateral direction (the fore-and-aft direction with respect to the advancing direction of the overhead travelling carriage 10) with respect to the direction in which the cassette 9 is conveyed.

In the present embodiment, the step portions 9c, 9c are formed at the respective ends of the bottom surface of the cassette 9. Alternatively, the bottom surface of the cassette 9 may be flat and the roller conveyors 8, 8 may be provided with guides to prevent the cassette 9 from moving obliquely.

When one side end (the front or rear end with respect to the advancing direction of the overhead travelling carriage 10) of the bottom surface of the cassette 9 is fed by the driving roller conveyor 8, the follower roller conveyor 8 is rotated, on which the other side end of the bottom surface of the cassette 9 is placed. Consequently, the cassette 9 is conveyed straight on the pair of roller conveyors 8, 8.

The pair of roller conveyors 54, 54, provided in the upper station 52 of the automatic warehouse 5, is configured similarly to the pair of roller conveyors 8, 8 of the overhead travelling carriage 10. Thus, one of the roller conveyors 54 acts as a driving conveyor, while the other roller conveyor 54 acts as a follower conveyor.

As described above, according to the present embodiment, for the roller conveyors 8, 8 of the overhead travelling carriage 10 and the roller conveyors 54, 54 of the upper station 52 of the automatic warehouse 5, one of the roller conveyors 8 (54) acts as a driving conveyor, while the other roller conveyor 8 (54) acts as a follower conveyor. However, the other roller conveyor 8 (54) may also be composed of a driving conveyor, i.e. both roller conveyors 8, 8 (54, 54) may be composed of driving conveyors. In this case, by synchronously driving both roller conveyors 8, 8 (54, 54), the cassette 9 is conveyed straight on the roller conveyors 8, 8 (54, 54).

The tips (at the respective sidewall openings of the carriage main body 10a) of each roller conveyor 8 of the overhead travelling carriage 10 are provided with respective stoppers 89 that can be moved in the vertical direction. While the cassette 9 is being conveyed, the stoppers 89 are projected above the conveying surfaces of the respective roller conveyors 8, 8 to prevent the cassette 9 from falling. On the other hand, when the cassette 9 is delivered to the roller conveyors 54, 54 of the upper station 52 of the automatic warehouse 5, the stoppers 89 are lowered from the conveying surfaces of the respective roller conveyors 8.

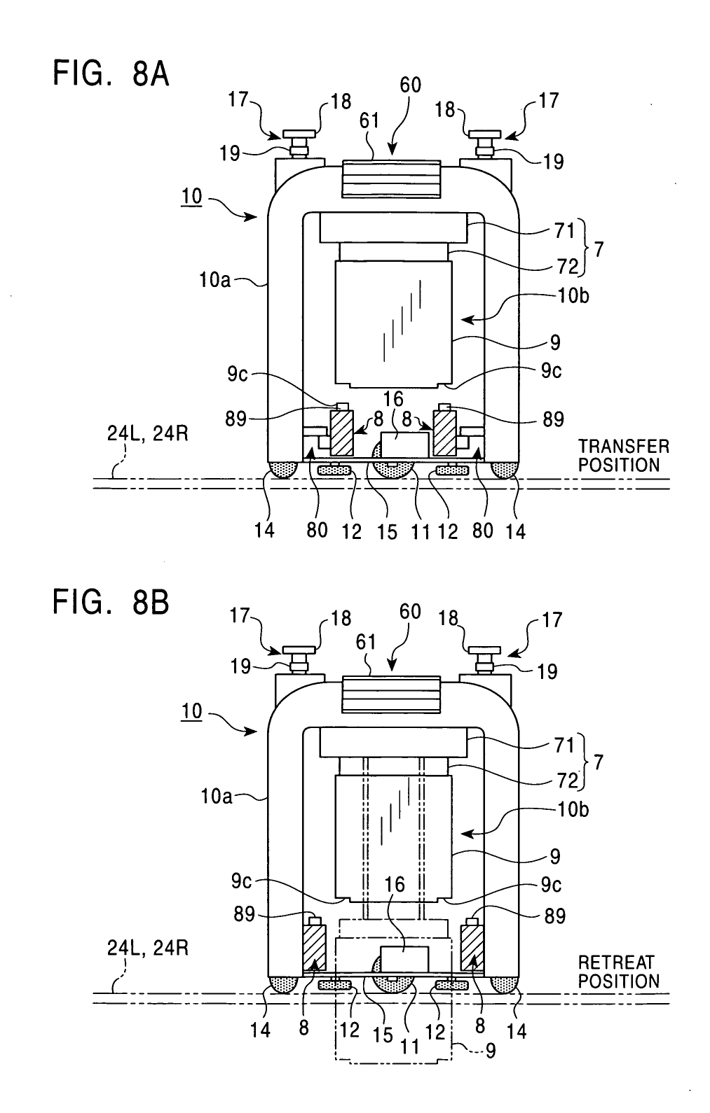

As shown in FIG. 8, the overhead travelling carriage 10 also comprises moving mechanisms 80, 80 that bring the roller conveyors 8, 8 close to or away from each other. The position at which the roller conveyors 8, 8 have been brought close to each other by the moving mechanisms 80, 80 is referred to as a “transfer position” (FIG. 8A). The position at which the roller conveyors 8, 8 have been brought away from each other by the moving mechanisms 80, 80 is referred to as a “retreat position” (FIG. 8B).

At the transfer position, the spacing between the roller conveyors 8, 8 is the same as the spacing between the roller conveyors 54, 54 of the upper station 52 of the automatic warehouse 5 and is thus smaller than the width of the cassette 9 (its length in the fore-and-aft direction with respect to the advancing direction of the carriage body). This makes it possible to deliver the cassette 9 to the upper station 52 of the automatic warehouse 5.

On the other hand, at the retreat position, the spacing between the roller conveyors 8, 8 is larger than the width of the cassette 9. Thus, the roller conveyors 8, 8 are positioned between the hoist 7 and the ground station 41 of the processing device 4 or the lower station 51 of the automatic warehouse 5. At this position, the delivery of the cassette 9 is not hindered. Consequently, the elevating and lowering portion 72 of the hoist 7 can pass between the roller conveyors 8, 8 in the vertical direction.

Each moving mechanism 80 is composed of a rack and pinion mechanism, a link mechanism, and a mechanism that moves the corresponding roller conveyor 8 forward and backward in the horizontal direction. The roller conveyors 8, 8 are configured as described above.

The means for delivering and receiving the cassette 9 to and from the upper station 52 of the automatic warehouse 5 in the direction orthogonal to the advancing direction of the overhead travelling carriage 10 is not limited to the roller conveyors 8, 8. Conveying means configured in other manners may be applied.

Furthermore, an onboard controller 110 is mounted on the overhead travelling carriage 10. As shown in FIG. 9, the onboard controller 110 is connected to the driving motor 16 for the driving wheel 11, a driving section for the hoist 7 and slide device 70, the driving motor for the rollers 88, 88, . . . of the roller conveyor 8, a driving section for the moving mechanisms 80, 80, a driving section for the branching devices 17, 17, and the equipment in the overhead travelling carriage 10.

A description will be given of the control of running of the overhead travelling carriage 10. Markers indicating positional information are stuck to appropriate positions on the running path 2, for example, positions above the stations 41, 41 of the processing device 4 in front of the passage ports 20, 20, . . . in the running path 2.

Moreover, the onboard controller 110, control means for the overhead travelling carriage 10, stores map information (data) on the running path 2 so that the overhead travelling carriage 10 can constantly determine its current running position. An encoder is mounted in the overhead travelling carriage 10 to indicate a running distance. Consequently, the onboard controller 110 determines the current position of the overhead travelling carriage 10 on the basis of the map information and running distance.

Accordingly, the onboard controller 110 of the overhead travelling carriage 10 also knows the positions of the large number of markers stuck to the running path 2. The overhead travelling carriage 10 uses a reader to detect a marker to check where it is presently running.

Then, when the reader detects a marker, if the current position of the overhead travelling carriage 10 determined by the encoder does not match the corresponding marker position on the map information, then the current position determined by the encoder is corrected on the basis of this marker position on the map information.

Thus, the overhead travelling carriage 10 constantly determines its current position on the basis of the map information stored in the onboard controller 110 and the running distance detected by the encoder. Furthermore, the reader is used to detect a marker to check the current position. Therefore, the current position is accurately determined using this double system.

The overhead travelling carriage 10 determines its running position on the running path 2 as described above; running control is executed on the basis of the map information and the markers. For example, when the marker located above the destined station 41 in front of the passage port 20 is detected, control is provided such that the overhead travelling carriage 10 is decelerated so as to stop at the passage port 20.

If the overhead travelling carriage 10 delivers the cassette 9 to the ground station 41 of the processing device 4, the upper station 52 of the automatic warehouse 5, or the roller conveyor 46 of the buffer 45, it determines at which stop position (a stop position for the ground station 41, a stop position for the upper station 52, or a stop position for the roller conveyor 46) it is presently located, on the basis of the map information stored in the onboard controller 110. The onboard controller 110 of the overhead travelling carriage 10 determines whether the hoist 7 or the roller conveyors 8 are used to deliver the cassette 9. If the roller conveyors 8 are to be used, the onboard controller 110 also determines the direction in which the rollers 88, 88, . . . are rotatively driven.

A higher controller may be provided which unitedly control the plurality of overhead travelling carriages 10, 10, . . . of the overhead travelling carriage system 1. Then, when the overhead travelling carriage 10 is stopped at the stop position for the ground station 41, upper station 52, or roller conveyor 46, the higher controller may give this overhead travelling carriage 10 an instruction as to whether to use the hoist 7 or the roller conveyors 8, 8.

The hoist 7 is selected when the overhead travelling carriage 10 is to deliver the cassette 9 to the ground station 41 of the processing device 4. On the other hand, the roller conveyors 8, 8 are selected when the overhead travelling carriage 10 is to deliver the cassette 9 to the upper station 52 of the automatic warehouse 5 or the roller conveyor 46 of the buffer 45. On this occasion, when the roller conveyors 8, 8 are selected, whether the driving motors is to be rotated in a normal or reverse direction is determined depending on whether the upper station 52 or the roller conveyor 46 is arranged at the laterally outer side (the outer side of the loop-like conveying path) or laterally inner side (the inner side of the loop-like conveying path) of the running path 2.

Now, a description will be given of the flow of the transfer of the cassette 9 using the hoist 7, mounted in the overhead travelling carriage 10.

As shown in FIG. 4, when the overhead travelling carriage 10, running on the running path 2, is stopped above the station 41 of the processing device 4 as a destination, the onboard controller 110 determines that the hoist 7 be used as transfer means for the current transfer operation.

The passage port 20 lies below the stopped overhead travelling carriage 10.

Thus, the slide device 70, holding the hoist 7, is used to adjust the lateral position of the hoist 7 so that it is located immediately above the cassette 9 on the ground station 41.

Then, the onboard controller 110 of the overhead travelling carriage 10 activates the moving mechanisms 80, 80 to move the roller conveyors 8, 8 to the retreat position. The onboard controller 110 then lowers the elevating and lowering portion of the hoist 7 (see FIG. 8B). The elevating and lowering portion 72 passes between the roller conveyors 8, 8 and through the passage port 20 and reaches the cassette 9 on the ground station 41. Then, the chuck of the elevating and lowering portion 72 grips the cassette 9, and the elevating and lowering portion 72 is then elevated. The elevating and lowering portion 72 passes through the passage port 20 and between the roller conveyors 8, 8. Then, the cassette 9 is housed in the article housing space 10b. Subsequently, the slide device 70, holding the hoist main body 71, is moved back to its original position.

After the cassette 9 has thus been completely housed, the moving mechanisms 80, 80 are activated again to move the roller conveyors 8, 8 to the transfer position (see FIG. 8A). At this time, the cassette 9 is and suspended in the article housing space 10b by being gripped by the elevating and lowering portion 72 of the hoist 7. Thus, the roller conveyors 8, 8 located at the transfer position serve to prevent the cassette 9 from falling. Alternatively, the elevating and lowering portion 72 may be slightly lowered to place the cassette 9 on the roller conveyors 8, 8 (see FIG. 7).

Conversely, if the cassette 9 held by the overhead travelling carriage 10 is transferred to the ground station 41 of the processing device 4, the hoist 7 is used to carry out substantially the same flow as that described above.

Now, a description will be given of the flow of the transfer of the cassette 9 using the roller conveyors 8, 8, mounted in the overhead travelling carriage 10.

As shown in FIG. 5 (or FIG. 3), when the overhead travelling carriage 10 is stopped at a side of and close to the upper station 52 of the automatic warehouse 5 (or the roller conveyor 46 of the buffer 45), the onboard controller 110 determines that the roller conveyors 8, 8 be used as transfer means for the current transfer operation. The rotative driving direction of the roller conveyors 8, 8 is also determined.

The roller conveyors 8, 8 of the stopped overhead travelling carriage 10 are located opposite and close to the roller conveyors 54, 54 of the automatic warehouse 5 (or the roller conveyor 46 of the buffer 45) so that all the conveyors 8, 8 and 54, 54 lie in a line at the same height. The onboard controller 110 of the overhead travelling carriage 10 selects the transfer means. The onboard controller 110 then lowers those stoppers 89, 80 of the roller conveyors 8, 8 which are located closer to the automatic warehouse 5 (or the buffer 45) and those stoppers 55, 55 of the roller conveyors which are located closer to the overhead travelling carriage 10 (or that stopper 49 of the roller conveyor 46 which is located closer to the overhead travelling carriage 10). At this time, those stoppers 89, 89 of the roller conveyors 8, 8 of the overhead travelling carriage 10 which are located opposite the automatic warehouse 5 (or the roller conveyor 46) remain elevated from the conveying surfaces to effect the stopper function.

Then, the roller conveyor 54 of the automatic warehouse (or the roller conveyor 46 of the buffer 45) or the driving roller conveyor 8 of the overhead travelling carriage 10 are driven to feed the cassette 9 out through the roller conveyors 54, 54 of the automatic warehouse 5 (or the roller conveyor 46 of the buffer 45). Furthermore, the cassette 9 is drawn in through the roller conveyors 8, 8 of the overhead travelling carriage 10. The cassette 9 is thus transferred from the automatic warehouse 5 (or the buffer 45) to the overhead travelling carriage 10. When the cassette 9 is loaded onto the overhead travelling carriage 10, the stoppers 89, 89 closer to the automatic warehouse 5 (or the buffer 45) are elevated to prevent the cassette 9 from falling.

After the cassette 9 has thus been completely housed in the overhead travelling carriage 10, the overhead travelling carriage 10 starts to run to the processing device 4 as a destination.

To hinder vibration from being transmitted to the cassette 9 during running, for example, the cassette 9 may be suspended, and presser members that can move forward and backward may be provided in front of and behind the article housing space 10b, respectively, on the respective inner sides of the carriage main body 10a to hold the respective sides of the cassette 9 (the front and rear sides with respect to the advancing direction of the overhead travelling carriage 10) during running. An elastomer is preferably provided in an abutting portion of each presser member so as to reduce the magnitude of a possible shock upon abutment against the cassette 9 and absorb vibration during running. Furthermore, an elastic member that can move forward and backward in the vertical direction or in the advancing direction of the overhead travelling carriage 10 may be arranged on the top surfaces of the roller conveyors 8, 8. Then, the cassette 9 may be placed on the roller conveyors 8, 8 via the elastic member.

Conversely, if the overhead travelling carriage 10 transmits the cassette 9 to the upper station 52 of the automatic warehouse 5 (or the roller conveyor 46 of the buffer 45), substantially the same flow as that described above is carried out using the roller conveyors 8, 8 of the overhead travelling carriage 10 and the roller conveyors 54, 54 of the upper station 52 of the automatic warehouse 5 (or the roller conveyor 46 of the buffer 45).

Thus, the overhead travelling carriage 10 is configured to deliver and receive the cassette 9 to and from the roller conveyor 46 of the buffer 45, located at the side of the running path 2. Compared to the arrangement in which an overhead travelling carriage with a hoist delivers and receives articles to and from a temporary article storage arranged below the running path, the cassettes can be delivered and received in a short time to make operations easier and more efficient.

Now, description will be given of a flow executed in the overhead travelling carriage system 1 to allow the overhead travelling carriage 10 to transfer and convey the cassette 9.

As shown in FIG. 1, the cassette 9 on the upper station 52 of the automatic warehouse 5 is transferred between the roller conveyors 54, 54 of the upper station 52 and the roller conveyors 8, 8 of the unloaded empty overhead travelling carriage 10 stopped at the side of the upper station 52. Then, the overhead travelling carriage 10 conveys the cassette 9 to the processing device 4 as the next destination. Alternatively, the cassette 9 moves on the roller conveyors 8, 8 in the lateral direction through the empty overhead travelling carriage 10 stopped at the side of the upper station 52. The cassette 9 is then transferred to the roller conveyor 46 of the buffer 45, standing opposite the upper station 52 across the running path 2.

Alternatively, in the latter case, a plurality of cassettes 9, 9, . . . may be sequentially outputted from the automatic warehouse 5 and then sequentially transferred to the respective roller conveyors 46, 46, . . . of the buffer 45 through the one empty overhead travelling carriage 10 stopped at the side of the upper station 52 of the automatic warehouse 5.

In this case, it is assumed that the conveyors 54, 54 of the upper station 52 of the automatic warehouse 5, the roller conveyors 8, 8 of the empty overhead travelling carriage 10 stopped at the side of the roller conveyors 54, 54, and the roller conveyor 46 of the buffer 45 are arranged in a line in a plan view. That is, it is assumed that the upper station 52 and the roller conveyor 46 of the buffer 45 are arranged symmetrically with respect to the running path 2. Then, the cassette 9 on the upper station 52 of the automatic warehouse 5 is conveyed directly to the roller conveyor 46 of the buffer 45 while being moved on the roller conveyors 8, 8 of the empty overhead travelling carriage 10 from the roller conveyors 54, 54 of the upper station 52 and without the need to move the overhead travelling carriage 10. However, for the roller conveyors 46 located upstream or downstream of the above roller conveyor 45, the cassette 9 on the upper station 52 of the automatic warehouse 5 is transferred from the roller conveyors 54, 54 of the upper station 52 to the roller conveyors 8, 8 of the empty overhead travelling carriage 10. Then, the overhead travelling carriage 10 is slightly moved forward or backward. Subsequently, the cassette 9 is transferred from the roller conveyors 8, 8 of the overhead travelling carriage 10 to the upstream or downstream roller conveyor 46.

Then, the cassettes 9, 9, . . . on the roller conveyors 46, 46, . . . are sequentially transferred to the respective overhead travelling carriages 10, 10, . . . , which have arrived at the side of the buffer 45 standing opposite the upper station 52 of the automatic warehouse 5. The cassettes 9, 9, . . . are then conveyed to the processing device 4 as a destination.

In this case, the cassettes 9, 9, . . . on the roller conveyors 46, 46, . . . of the buffer 45 are transferred in a first-in first-out manner.

For example, when the plurality of cassettes 9, 9, . . . outputted from the automatic warehouse 5 are temporarily placed in the buffer via one empty overhead travelling carriage 10, they are sequentially placed on the respective roller conveyors 46; the first cassette 9 is placed on the roller conveyor 46 located downstream (with respect to the advancing direction of the overhead travelling carriage 10) of the buffer 45 and the last cassette is place on the most upstream roller conveyor 46. Then, when the temporarily placed cassettes 9, 9, . . . are transferred to the plurality of empty overhead travelling carriages 10, 10, . . . arriving at the side of the buffer 45, the cassette 9 on the downstream roller conveyor 46 on which the cassette 9 was placed first is transferred first.

Alternatively, conversely, the plurality of cassettes 9, 9, . . . outputted from the automatic warehouse 5 may be sequentially temporarily placed on the respective roller conveyors 46; the first cassette 9 is placed on the most upstream roller conveyor 46 and the last cassette 9 is placed on the most downstream roller conveyor 46. Then, when the temporarily placed cassettes 9, 9, . . . are transferred to the plurality of empty overhead travelling carriages 10, 10, . . . arriving at the side of the buffer 45, the cassette 9 on the upstream roller conveyor 46 on which the cassette 9 was placed first may be transferred first.

Furthermore, a higher controller that unitedly manages the overhead travelling carriage system 1 may manage the order of the roller conveyors 46, 46, . . . on which the plurality of cassettes 9, 9, . . . outputted from the automatic warehouse 5 are temporarily placed. Subsequently, when the temporarily placed cassettes 9, 9, . . . are transferred to the plurality of empty overhead travelling carriages 10, 10, . . . arriving at the side of the buffer 45, the cassettes 9 may be sequentially transferred starting with the one temporarily placed on one of the roller conveyors 46 first, on the basis of an instruction from the controller.

As described previously, the processing device 4 processes the wafers in the plurality of cassettes 9, 9, . . . at a time. The maximum number of cassettes 9, 9, . . . that can be processed by the processing device 4 is limited. Accordingly, when the maximum number of cassettes 9, 9, . . . that can be processed have been loaded into the processing device 4, even if the overhead travelling carriage 10 holding the cassette 9 arrives, this new cassette 9 is transferred to the buffer 45 located close to the processing device 4 because no more cassettes 9 can be loaded into the processing device 4.

It takes a relatively long time to process the wafers in the cassettes 9, 9, . . . using the processing device 4. Thus, when the overhead travelling carriages 10 holding the respective cassettes 9 arrive one after another during this processing, the new cassettes 9 are temporarily placed on the buffer 4 located close to the processing device 4.

Then, once the processing device 4 has completed its processing, the plurality of cassettes 9, 9, . . . are sequentially outputted to the ground station 41 through the output port starting with the one inputted first. The cassettes 9, 9, . . . are then transferred by the hoist 7 of the overhead travelling carriage 10 stopped on the running path 2 immediately above the ground station 41.

Thus, the processed plurality of cassettes 9, 9, . . . from the ground station 41 are sequentially loaded onto the respective overhead travelling carriages 10, 10, . . . and then conveyed to the processing device 4 for the next process step. Then, other empty overhead travelling carriages 10 arriving at the processing device 4 sequentially transfer, to the ground station 41 of the processing device, those of the cassettes 9, 9, . . . temporarily stored on the roller conveyors 46, 46, . . . of the buffer 45 located close to the processing device 4 which are to be newly processed by the processing device 4.

At this time, the cassette 9 on each roller conveyor 46 of the buffer 45 is transferred to the roller conveyors 8, 8 of the overhead travelling carriage 10 stopped at the side of this roller conveyor 46. This overhead travelling carriage 10 is moved to a position immediately above the ground station 41 to which the cassette 9 is to be transferred. Then, the cassette 9 is held by the hoist 7 and transferred to the ground station 41 while passing through the passage port 20 in the vertical direction.

However, for the cassette 9 on the roller conveyor 46 (this roller conveyor 46 and the ground station 41 line up straight in a plan view) located at the side of and close to the destined ground station 41 as viewed from the passage port 20, located immediately above the ground station 41, this cassette 9 is transferred from the roller conveyor 46 to the roller conveyors 8, 8 on the overhead travelling carriage 10. The cassette 9 is then transferred by the hoist 7 to the ground station 41 located below, with the overhead travelling carriage 10 remaining stopped.

Also on this occasion, the plurality of new cassettes 9, 9, . . . on the roller conveyors 46, 46, . . . of the buffer 45 are transferred to the ground station 41 of the processing device 4 in a first-in first-out manner.

Then, the plurality of new cassettes 9, 9, . . . from the ground station 41 are loaded into the processing device 4. Then, the processing device 4 executes a series of operations.

Once the plurality of cassettes 9, 9, . . . are completely processed in the final processing device 4 in accordance with the above flow, they are sequentially outputted to the ground station 41 starting with the cassette inputted first. The cassettes 9, 9, . . . are transferred to the overhead travelling carriage 10 stopped on the running path 2 immediately above the ground station 41.

Thus, the plurality of cassettes 9, 9, . . . are sequentially transferred to the respective overhead travelling carriages 10, 10, . . . and are conveyed to the automatic warehouse 5. Then, each overhead travelling carriage 10 is stopped at the side of the automatic warehouse 5. The cassette 9 is then transferred from the roller conveyors 8, 8 of the overhead travelling carriage 10 to the roller conveyors 54, 54 of the upper station 52 of the automatic warehouse. The cassette 9 is finally inputted to the automatic warehouse 5.

As described above, the cassette 9 is outputted from the automatic warehouse 5 and then conveyed on the overhead travelling carriage 10. While being conveyed, the cassette 9 undergoes processing in the processing devices 4, 4, . . . Subsequently, the cassette 9 is inputted to the automatic warehouse 5.

The overhead travelling carriage 10 is equipped with the hoist 7, which delivers the cassette 9 in the vertical direction, and the roller conveyors 8, 8 on which the cassette 9 is delivered in the lateral direction. This enables the overhead travelling carriage 10 to be used for more purposes. When delivering the cassette 9 to the ground station 41 of the processing device 4, the overhead travelling carriage 10 uses the onboard controller 110, control means, to set the roller conveyors 8, 8 at the retreat position and then elevate or lower the hoist. On the other hand, when delivering the cassette 9 to the upper station 52 of the automatic warehouse 5 or the roller conveyor 46 of the buffer 45, the overhead travelling carriage 10 uses the onboard controller 110 to set the roller conveyors 8, 8 at the transfer position and then activate them.

When the overhead travelling carriage 10 delivers the cassette 9 to the ground station 41 located below the running path 2, the moving mechanisms 80, 80 move the roller conveyors 8, 8 to the retreat position. Then, the cassette 9, elevated and lowered via the hoist 9, and the roller conveyors 8, 8 do not interfere with each other. This makes it possible to arrange the hoist 7 and roller conveyors 8, 8 in the overhead travelling carriage 10 to achieve a compact layout.

Moreover, by using the moving mechanisms 80, 80 to move the roller conveyors 8, 8 to the transfer position, it is possible to prevent the falling of the cassette 9 held within the article housing space 10b by the hoist 7. Therefore, the safety of the system is improved.

In this arrangement, the overhead travelling carriages 10 each equipped with the hoist 7 and the roller conveyors 8, 8 run on the running path 2. However, it is allowable that the overhead travelling carriages 10 each equipped with the hoist 7 and the roller conveyors 8, 8 run on the running path 2 concurrently with the overhead travelling carriages 10 each equipped only with the roller conveyors 8, 8 and not with the hoist 7.

The overhead travelling carriage 10 equipped with the hoist 7 and the roller conveyors 8, 8 will hereinafter be referred to as a first overhead travelling carriage. The overhead travelling carriage 10 equipped only with the roller conveyors 8, 8 will hereinafter be referred to as a second overhead travelling carriage. The second overhead travelling carriage can be manufactured more inexpensively than the first overhead travelling carriage. Accordingly, by using the minimum number of first overhead travelling carriages present and a correspondingly increased number of second overhead travelling carriages within the overhead travelling carriage system 1, it is possible to reduce the costs of the construction of the overhead travelling carriage system 1.

In the system in which both the first overhead travelling carriages and the second overhead travelling carriages are present, the first overhead travelling carriage transfers the cassette 9 between the upper station 52 of the automatic warehouse 5 and the ground station 41 of the processing device 4, between the ground station 41 of the processing device 4 and the ground station 41 of the different processing device 4, and between the roller conveyor 46 of the buffer 45 and the ground station of the processing device 4. The second overhead travelling carriage mainly transfers the cassette 9 between the automatic warehouse 5 and the roller conveyor 46 of the buffer 45, and between the roller conveyor 46 of the buffer 45 and the roller conveyor 46 of the different buffer 45.

As described previously, the plurality of cassettes 9, 9, . . . are loaded into the processing device 4 all together. Then, the processing device 4 processes a plurality of cassettes 9 at a time. Subsequently, the processing device 4 sequentially loads the processed plurality of cassettes 9, 9, . . . directly onto the respective first overhead travelling carriages. The plurality of cassettes 9, 9, . . . may be conveyed to the next processing device 4 using the respective first overhead travelling carriages. Alternatively, a single first overhead travelling carriage may be used to transfer sequentially the processed plurality of cassettes 9, 9, . . . from the ground station 41 to the buffer 45 located closest to the processing device 4. Then, the plurality of cassettes already transferred to the buffer 45 may be sequentially loaded onto the respective second overhead travelling carriages and then conveyed to the next processing device 4.

A description has been given of the configuration of the overhead travelling carriage system 1 according to the present invention.

The overhead travelling carriage set forth in the claims is not limited to the mount type overhead travelling carriage 10 in the above embodiment, which supports the cassette 9 above the rails 24L, 24R. The overhead travelling carriage may be of a suspension type that runs while suspending the article below the rails.

With the suspension type overhead travelling carriage, an article housing space is formed below the rails 24L, 24R. An opening is formed below the article housing space so that the cassette 9 can be passed through the opening in the vertical direction. Openings are also formed in those sides of the overhead travelling carriage which lie in the direction orthogonal to the advancing direction of the overhead travelling carriage (the direction in which the cassette 9 is transferred). The cassette 9 can be passed through these openings in the lateral direction. A hoist is arranged on the ceiling of the article housing space. Roller conveyors are arranged in front of and behind the article housing space, respectively, as a horizontal moving device. The roller conveyors move forward and backward so as not to interfere with the elevation and lowering of the cassette 9 using the hoist.

Furthermore, during processing in the processing device 4, the empty cassette 9 is stored in the processing device 4. However, it may be temporarily stored in the buffer 45.

The paresent invention configured as described above produces the effects described below.

First, according to the aspect of the present invention set forth in claim 1, the overhead travelling carriage is conveying means configured to deliver and receive the article to and from the buffer arranged at the side of the running path and comprising the loading and unloading means. Compared to the conventional arrangement in which the hoist delivers and receives the article to and from the temporary article storage arranged below the running path, the article can be delivered and received in a short time to make operations easier and more efficient.

According to the aspect of the present invention set forth in claim 2, the overhead travelling carriage is conveying means and can deliver and receive the article to and from the upper station in a short time, which is arranged at the side of the running path and which comprises the input and output means. This also makes operations easier and more efficient.

According to the aspect of the present invention set forth in claim 4, the overhead travelling carriage is stopped between the buffer and the upper station. Accordingly, the article from the buffer can be delivered to the upper station via the overhead travelling carriage in a short time, vice versa. When the article from the buffer is delivered to the upper station via the overhead travelling carriage, vice versa, the overhead travelling carriage only relays the article. Furthermore, the article mounted in the overhead travelling carriage can be loaded onto either the buffer or the upper station. Alternatively, a new article from the buffer or the upper station can be loaded onto the overhead travelling carriage. The loading and unloading can be carried out substantially simultaneously to reduce the time required for transfer.

1. An overhead travelling carriage system comprising overhead travelling carriages each conveying an article and a running path along which the overhead travelling carriages run, the system being characterized:
in that conveying means is mounted in each of the overhead travelling carriages to load and unload an article in a direction orthogonal to a direction in which a carriage body advances, and
buffers are arranged at a side of the running path at a height corresponding to the conveying means of each overhead travelling carriage, the buffers each comprising loading and unloading means for delivering and receiving an article to and from the conveying means of the overhead travelling carriage.

2. An overhead travelling carriage system according to claim 1, characterized in that upper stations are arranged at a side of the running path at a height corresponding to the conveying means of each overhead travelling carriage, the upper stations each comprising input and output means for delivering and receiving an article to and from the conveying means of the overhead travelling carriage.

3. An overhead travelling carriage system according to claim 1, characterized in that ground stations are arranged below the running path, and a hoist is mounted in each overhead travelling carriage to deliver and receive an article to and from the ground stations in a vertical direction.

4. An overhead travelling carriage system according to claim 2, characterized in that each of the buffers and the corresponding upper station are arranged opposite each other across the running path.

5. An overhead travelling carriage system according to claim 2, characterized in that ground stations are arranged below the running path, and a hoist is mounted in each overhead travelling carriage to deliver and receive an article to and from the ground stations in a vertical direction.

6. An overhead travelling carriage system according to claim 4, characterized in that ground stations are arranged below the running path, and a hoist is mounted in each overhead travelling carriage to deliver and receive an article to and from the ground stations in a vertical direction.
